(19) United States
(12) Patent Application Publication
(10) Pub. No.: US 2026/0192405 A1
(43) Pub. Date: Jul. 9, 2026

(54) A Process Method For Automatic Feeding And Discharging For CNC Lathe

(71) Applicant: Shenzhen Fushijie Intelligent Robot Co., Ltd., Shenzhen, Guangdong (CN)

(72) Inventor: Xuehong Liu, Shenzhen, Guangdong (CN)

(21) Appl. No.: 19/131,843

(22) PCT Filed: Sep. 25, 2023
(86) PCT No.: PCT/CN2023/121065

§ 371 Date: May 21, 2025

(30) Foreign Application Priority Data
Nov. 23, 2022 (CN) 202211476428.4

(51) Int. Cl. B23Q 7/04; B23Q 39/04

(52) U.S. Cl. CPC B23Q 7/041; B23Q 7/046; B23Q 7/048; B23Q 39/046

(57) ABSTRACT

The present invention discloses a process method for automatic feeding and discharging for CNC lathe, belonging to the field of CNC lathe technology, and the process method for automatic feeding and discharging for CNC lathe comprises a process in which a manipulator feeds and discharges material when the CNC lathe is processing a single-procedure product, a process in which a manipulator feeds and discharges material and flips the process surface of workpiece when the CNC lathe is processing a multi-procedure product, so that the use of the manipulator for feeding and discharging material for CNC lathe, the automatic process surface flipping mechanism and clamping jaw mechanism dispenses with manual flipping, reduces production costs and improves the production efficiency of CNC lathes; the process method can complete the production of multi-procedure finished products by a single machine, reduce the number of machines, while making large improvement in terms of production capacity, yield rate and personnel working environment, and effectively controlling the processing costs free from the restriction of personnel management in the processing industry.

### TECHNICAL FIELD

The present invention relates to the field of CNC lathe technology, and more specifically, to a process method for automatic feeding and discharging for CNC lathe.

### BACKGROUND

A computer numerical control machine tool (CNC machine tool) is an automated machine tool having a program control system, and is operated to process parts according to a pre-programmed program. CNC machine tool integrates mechanical, automation, computer, microelectronics and other technologies to address the processing problems of complex, precise and small batch parts, and is a flexible and efficient automated machine tool with strong adaptability to the processing object, high processing accuracy, stable processing quality, and high productivity and reliability to improve working conditions.

With the rapid development of industrial technology in China, intelligent CNC machine tools have shown gradually matured development technologies, and it is an inevitable trend to develop intelligent CNC machine tools in the industrial development in China. Applying intelligent CNC machine tools in industrial production can effectively improve China's industrial production level and ensure the accurate internal testing for machine tools.

The traditional material feeding and discharging machine for CNC lathe requires the CNC lathe tool, material platform, and clamping jaw mechanism (or the clamp, the same below), and the process flow is as follows: the material is manually placed on the material platform, then grasped by the clamping jaw mechanism and moved to the chuck, and the material processed by the CNC lathe is then collected by the clamping jaw mechanism to the material platform, which is a process flow for single-procedure product processing; For multi-procedure products, after the material is grasped by the clamping jaw mechanism to the material platform, the process surface of material has to be manually flipped. The traditional automatic material feeding and discharging process flow for CNC lathe can only meet the automatic material feeding and discharging of single-procedure products, and for multi-procedure products, manual assistance is required to flip the process surface. The traditional feeding and discharging machine has two sets of clamping jaw mechanisms, which cannot meet the needs of grasping multi-procedure products.

### SUMMARY

### 1. Technical Problems to be Addressed

In response to the existing problems in the prior art, the present invention aims to provide a process method for automatic feeding and discharging for CNC lathe, so that the process surface used for automatic feeding and discharging for CNC lathe can be automatically flipped and grasped without manual flipping, reducing production costs and improving the production efficiency of CNC lathes; the process method can complete the production of multi-procedure finished products by a single machine, reduce the number of machines, while making large improvement in terms of production capacity, yield rate and personnel working environment, and effectively controlling the processing costs free from the restriction of personnel management in the processing industry.

### 2. Technical Solution

To address the above problems, the present invention adopts the following technical solution.

A process method for automatic feeding and discharging for CNC lathe, comprising the following steps:
S1. A process flow in which a trust manipulator performs the first feeding and discharging for the CNC lathe when the CNC lathe is processing a single-procedure product;
S2. A process flow in which a trust manipulator performs the second feeding and discharging for the CNC lathe (and all subsequent unprocessed materials in this procedure) when the CNC lathe is processing a single-procedure product;
S3: A process flow in which a trust manipulator performs the first feeding and discharging in the first procedure for the CNC lathe when the CNC lathe is processing a multi-procedure product;
S4: A process flow in which a trust manipulator performs the second feeding and discharging in the first procedure for the CNC lathe (and all subsequent unprocessed materials in this procedure) when the CNC lathe is processing a multi-procedure product;
S5: A process flow in which a trust manipulator performs the first feeding and discharging in the second procedure for the CNC lathe when the CNC lathe is processing a multi-procedure product;
S6: A process flow in which a trust manipulator performs the second feeding and discharging in the second procedure for the CNC lathe (and all subsequent unprocessed materials in this procedure) when the CNC lathe is processing a multi-procedure product;
The process surface used for automatic feeding and discharging for CNC lathe can be automatically flipped and grasped without manual flipping, reducing production costs and improving the production efficiency of CNC lathes; the process method can complete the production of multi-procedure finished products by a single machine, reduce the number of machines, while making large improvement in terms of production capacity, yield rate and personnel working environment, and effectively controlling the processing costs free from the restriction of personnel management in the processing industry.

In further, S1 comprises the following specific steps:
S11: Manually place unprocessed material on a material platform;
S12: The truss manipulator grasps unprocessed material from the material platform through 1 #clamping jaw on the clamping jaw mechanism, and the clamping jaw mechanism driven by the truss manipulator moves to an appropriate position outside the CNC lathe, and waits for the CNC lathe to complete the processing of the material from the previous procedure;
S13: After the material from the previous procedure is processed, the clamping jaw mechanism driven by the truss manipulator moves to the appropriate position on the chuck of the CNC lathe, 2 #clamping jaw grasps the processed material on the chuck, the clamping jaw mechanism rotates 1 #clamping jaw to an appropriate working position to place the unprocessed material into the chuck and, under the drive of truss manipulator, the clamping jaw mechanism clamping processed material moves outside the CNC lathe;
S14: Under the drive of truss manipulator, the clamping jaw mechanism clamping processed material moves to an appropriate position on the material platform, and places processed material back to the corresponding numbered position on the material platform.

In further, S2 comprises the following specific steps:
S21: The truss manipulator grasps unprocessed material from material platform through 1 #clamping jaw on the clamping jaw mechanism, the clamping jaw mechanism driven by the truss manipulator moves to an appropriate position outside the CNC lathe, and waits for the CNC lathe to complete the processing of the material from the previous procedure;
S22: After the material from the previous procedure is processed, the clamping jaw mechanism driven by truss manipulator moves to an appropriate position on the chuck of the CNC lathe, 2 #clamping jaw grasps the processed material on the chuck, the clamping jaw mechanism rotates 1 #clamping jaw to the appropriate working position to place unprocessed material b on the chuck and, under the drive of truss manipulator, the clamping jaw mechanism clamping processed material moves outside the CNC lathe;
S23: Under the drive of truss manipulator, the clamping jaw mechanism clamping processed material moves to an appropriate position on the material platform, and places processed material back to the corresponding numbered position on the material platform.
S24: After the truss manipulator performs operations for the CNC lathe for the third time, the process flow of feeding and discharging of all materials is the same as that of the second time, repeat the steps S21, S22 and S23 continuously to automatically complete the feeding and discharging of all materials on the material platform.

In further, S3 comprises the following specific steps:
S31: Manually place unprocessed material on the material platform;
S32: The truss manipulator grasps unprocessed material from the material platform through 1 #clamping jaw on the clamping jaw mechanism, and the clamping jaw mechanism driven by the truss manipulator moves to an appropriate position outside the CNC lathe, and waits for the CNC lathe to complete the processing of the material from the previous procedure;
S33: After the material from the previous procedure is processed, the clamping jaw mechanism driven by truss manipulator moves to an appropriate position on the chuck of the CNC lathe, 2 #clamping jaw grasps the processed material on the chuck, the clamping jaw mechanism rotates 1 #clamping jaw to an appropriate working position to place the unprocessed material a into the chuck and, under the drive of truss manipulator, the clamping jaw mechanism clamping processed material moves outside the CNC lathe;
S34: Driven by the truss manipulator, the clamping jaw mechanism clamping processed material moves to an appropriate position on the material transfer platform, places processed material on a material tray of the material transfer platform and, according to the material processing technology and material size, the clamping jaw mechanism rotates 1 #clamping jaw to the working position;
S35: According to the needs of flipping process surface during material processing, the automatic process surface flipping mechanism grasps processed material from the material tray of transfer platform, and after flipping to the process surface in the second procedure, places the processed material back on the material tray of material transfer platform to meet the needs of flipping process surface of processed material;
S36: Driven by the truss manipulator, 1 #clamping jaw of clamping jaw mechanism grasps, from the material tray of material transfer platform, the processed material for which the process surface has been flipped, and moves and places processed material back to the corresponding numbered position on the material platform.

In further, S4 comprises the following specific steps:
S41: The clamping jaw mechanism rotates 1 #clamping jaw to the working position, the 1 #clamping jaw on the clamping jaw mechanism grasps the unprocessed material, and under the drive of the truss manipulator, moves to an appropriate position outside the CNC lathe, and waits for the CNC lathe to complete the processing of the material from the previous procedure;
S42: After the material from the previous procedure is processed, the clamping jaw mechanism driven by the truss manipulator moves to an appropriate position on the chuck of the CNC lathe, 2 #clamping jaw grasps the processed material on the chuck, the clamping jaw mechanism rotates 1 #clamping jaw to the working position to place unprocessed material on the chuck and, under the drive of the truss manipulator, the clamping jaw mechanism clamping the processed material moves outside the CNC lathe;
S43: Driven by the truss manipulator, the clamping jaw mechanism clamping processed material moves to an appropriate position on the material transfer platform, places processed material on a material tray of the material transfer platform and, according to the material processing technology and material size, the clamping jaw mechanism rotates or moves 1 #clamping jaw to the working position;
S44: According to the needs of flipping process surface during material processing, the automatic process surface flipping mechanism grasps processed material from the material tray of transfer platform, and after flipping to the process surface in the second procedure, places the processed material back on the material tray of material transfer platform to meet the needs of flipping process surface of processed material;
S45: Driven by the truss manipulator, 1 #clamping jaw of clamping jaw mechanism grasps, from the material tray of material transfer platform, the processed material for which the process surface has been flipped, moves and places processed material back to the corresponding numbered position on the material platform;
S46: After the truss manipulator performs the third feeding and discharging for the CNC lathe in the first procedure, the process flow of feeding and discharging all materials is the same as the second feeding and discharging in the first procedure, and repeat steps S41, 442, S43, S44, and S45 continuously to automatically complete the feeding and discharging of all materials on the material platform and the flipping of process surface in the first procedure;
S47: The CNC lathe switches to the second procedure of material processing under manual operation.

In further, S5 comprises the following specific steps:
S51: The truss manipulator grasps the material for secondary processing from the material platform through 1 #clamping jaw on the clamping jaw mechanism, and the clamping jaw mechanism driven by the truss manipulator moves to an appropriate position outside the CNC lathe, and waits for the CNC lathe to complete the processing of the material from the previous procedure;
S52: After the material from the previous procedure is processed, the clamping jaw mechanism driven by the truss manipulator moves to an appropriate position on the chuck of the CNC lathe, 3 #clamping jaw grasps the processed material on the chuck, and the clamping jaw mechanism rotates 1 #clamping jaw to the appropriate working position to place the material for secondary processing into the chuck and, under the drive of the truss manipulator, the clamping jaw mechanism clamping processed material moves outside the CNC lathe;
S53: Driven by the truss manipulator, the clamping jaw mechanism clamping processed material moves to an appropriate position on the material platform to place the secondary-processed material back to the corresponding numbered position on the material platform.

In further, S6 comprises the following specific steps:
S61: The clamping jaw mechanism rotates 1 #clamping jaw to the working position, the 1 #clamping jaw on the clamping jaw mechanism grasps the material for secondary processing, and under the drive of the truss manipulator, moves to an appropriate position outside the CNC lathe, and waits for the CNC lathe to complete the processing of the material from the previous procedure;
S62: After the material from the previous procedure is processed, the clamping jaw mechanism driven by the truss manipulator moves to an appropriate position on the chuck of the CNC lathe, 3 #clamping jaw grasps the secondary-processed material on the chuck, the clamping jaw mechanism rotates 1 #clamping jaw to the working position to place the material for secondary processing on the chuck and, under the drive of the truss manipulator, the clamping jaw mechanism clamping the secondary-processed material moves outside the CNC lathe;
S63: Driven by the truss manipulator, the clamping jaw mechanism clamping secondary-processed material moves to an appropriate position on the material transfer platform, and places secondary-processed material on the corresponding numbered position on the material platform;
S64: After the truss manipulator performs the third feeding and discharging for the CNC lathe in the second procedure, the process flow of feeding and discharging all materials is the same as the second feeding and discharging in the second procedure, and repeat steps S61, S62, and S63 continuously to automatically complete the feeding and discharging of all materials on the material platform in the second procedure until all materials on the material platform are processed;
In further, the automatic feeding and discharging equipment comprises a bracket, a material transfer platform, a second material transfer platform, and a material platform body, the upper end of the bracket is fixedly connected to a feeding and discharging manipulator, the front end of the feeding and discharging manipulator is fixedly installed with a clamping jaw mechanism, the upper end of the material transfer platform is fixedly installed with an automatic process surface flipping mechanism and a transfer platform material tray, respectively, and the upper end of the second material transfer platform is fixedly installed with a second automatic process surface flipping mechanism and a second transfer platform material tray, respectively, and the upper end of the material platform body is fixedly installed with a material tray of material platform, and based on the newly added first material transfer platform and the improvement of existing clamping jaw mechanism, the automatic process surface flipping and clamping jaw used for the automatic feeding and discharging for CNC lathe can grasp material without manual flipping, reducing production cost and improving the production efficiency of CNC lathe.

In further, the clamping jaw mechanism comprises a clamping jaw control console that is fixedly installed at the front end of the feeding and discharging manipulator, and the side ends of clamping jaw control console are fixedly installed with 1 #clamping jaw and 2 #clamping jaw, and the lower end of the clamping jaw control console is fixedly installed with 3 #clamping jaw, and the upper end of the material transfer platform is also fixedly installed with a vision system and a scanning detection instrument to scan and inspect the external dimensions and surface of processed materials, and based on the multiple clamping jaws installed, the process surface flipping method and grasping method can be directly selected in the control system according to actual needs.

In further, the automatic process surface flipping mechanism comprises two methods for flipping surface process:
A1: Flip the bottom to the top (180)°;
A2: Do not flip the process surface;
There are four methods for grasping by clamping jaw:
B1: there is little difference in clamping diameter before and after material processing. 1 #clamping jaw clamps the upper workpiece, 2 #clamping jaw clamps the lower workpiece and 1 #clamp picks up the workpiece;
B2: there is little difference in clamping diameter before and after material processing. 1 #clamping jaw clamps the upper workpiece, 2 #clamping jaw clamps the lower workpiece and 3 #clamp picks up the workpiece;
B3: there is little difference in clamping diameter before and after material processing. 1 #clamping jaw clamps the upper workpiece, and 2 #clamping jaw clamps the lower workpiece;
B4: there is a large difference in clamping diameter before and after material processing. 1 #clamping jaw clamps the upper workpiece and 3 #clamping jaw clamps the lower workpiece.

Based on the effective arrangement and combination of the process surface flipping methods and the grasping methods by clamping jaw, four common process methods can be combined.

### 3. Beneficial Effects

Compared to prior art, the present invention has the following advantages:

(1) In the solution, the automatic process surface flipping and clamping jaw used for the automatic feeding and discharging for CNC lathe can grasp material without manual flipping, reducing production costs and improving the production efficiency of CNC lathes; the process method can complete the production of multi-procedure finished products by a single machine, reduce the number of machines, while making large improvement in terms of production capacity, yield rate and personnel working environment, and effectively controlling the processing costs free from the restriction of personnel management in the processing industry.

(2) In the solution, the automatic feeding and discharging equipment comprises a bracket, a material transfer platform, a second material transfer platform, and a material platform body, the upper end of the bracket is fixedly connected to a feeding and discharging manipulator, the front end of the feeding and discharging manipulator is fixedly installed with a clamping jaw mechanism, the upper end of the material transfer platform is fixedly installed with an automatic process surface flipping mechanism and a transfer platform material tray, respectively, and the upper end of the second material transfer platform is fixedly installed with a second automatic process surface flipping mechanism and a second transfer platform material tray, respectively, and the upper end of the material platform body is fixedly installed with a material tray of material platform, and based on the newly added first material transfer platform and the improvement of existing clamping jaw mechanism, the automatic process surface flipping and clamping jaw used for the automatic feeding and discharging for CNC lathe can grasp material without manual flipping, reducing production cost and improving the production efficiency of CNC lathe.

(3) In the solution, a vision system and a scanning detection instrument are fixedly installed on the upper end of the first material transfer platform to scan and inspect the external dimensions and surface of processed materials.

### BRIEF DESCRIPTION OF THE DRAWINGS

FIG. 1 is a three-dimensional structural diagram of the automatic feeding and discharging equipment of the present invention;

FIG. 2 is a three-dimensional structural diagram of the first material transfer platform of the present invention;

FIG. 3 is a three-dimensional structural diagram of the second material transfer platform of the present invention;

FIG. 4 is a three-dimensional structural diagram of the material platform of the present invention;

FIG. 5 is a three-dimensional structural diagram of the clamping jaw mechanism of the present invention;

FIG. 6 is a schematic diagram of the automatic flipping and clasping process method for the process surface of the present invention.

FIG. 7 is a list of the process flow diagrams of the automatic flipping and grasping of the present invention.

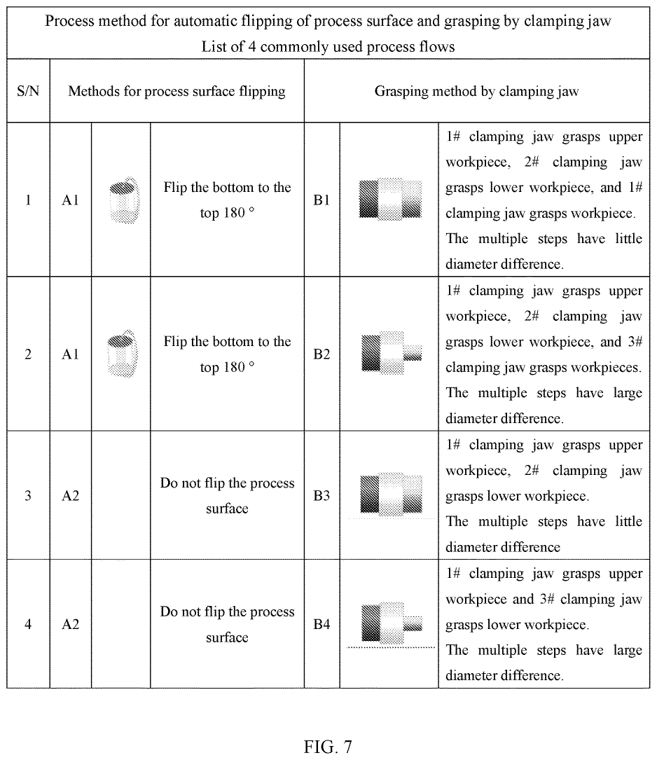

Where:
1. Bracket; 2. Feeding and discharging manipulator; 3. Clamping jaw mechanism; 31. Clamping jaw control console; 32. 1 #clamping jaw; 33. 2 #clamping jaw; 34. 3 #clamping jaw; 4. Material transfer platform; 5. Automatic process surface flipping mechanism; 6. Transfer platform material tray; 7. Second material transfer platform; 8. Second automatic process surface flipping mechanism; 9. Second transfer platform material tray; 10. Material platform body; 11. Material platform material tray.

### DETAILED DESCRIPTION OF EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

In the description of the present invention, it should be noted that the terms “up”, “down”, “inside”, “outside”, “top/bottom”, etc. indicate orientation or position relationships based on the orientation or position relationships shown in the accompanying drawings, only for the convenience of describing the present invention and simplifying the description, and do not indicate or imply that the device or element referred to must have a specific orientation, be constructed and operated in a specific orientation, and therefore cannot be understood as limiting the present invention. In addition, the terms “first” and “second” are only used for descriptive purposes and cannot be understood as indicating or implying relative importance.

In the description of the present invention, it should be noted that unless otherwise specified and limited, the terms “installation”, “provided with”, “sleeved/connected with”, “connection”, etc. should be broadly understood and, for example, “connection” can be a fixed connection, a detachable connection, or an integral connection; and can be a mechanical connection or an electrical connection; can be direct connection, indirect connection through an intermediate medium, or internal connection between two assemblies. The person having ordinary skill in the art can understand the specific meanings of the above terms in the present invention in specific situations.

### EXAMPLE 1

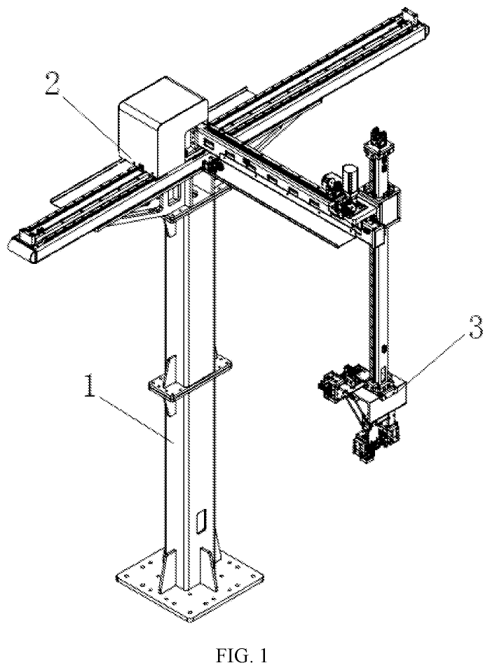

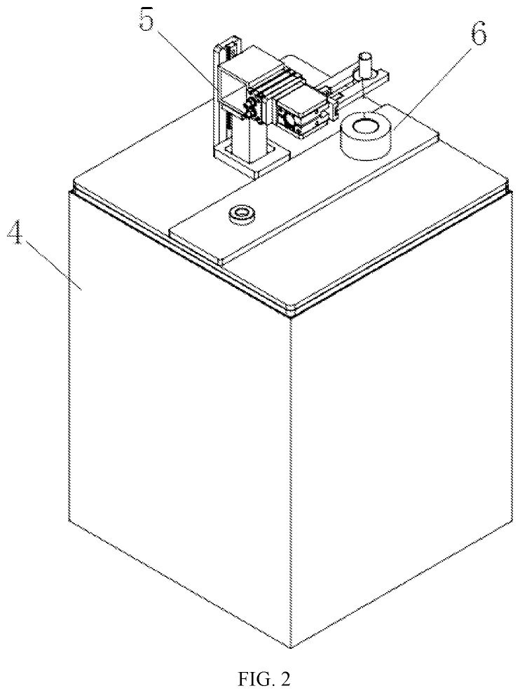

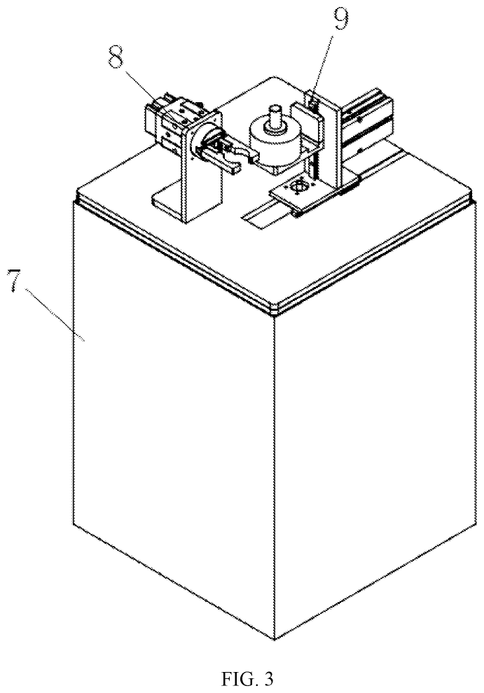

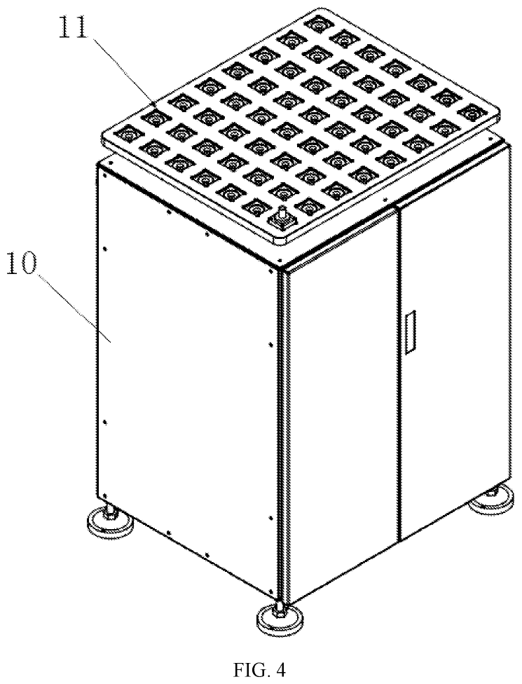

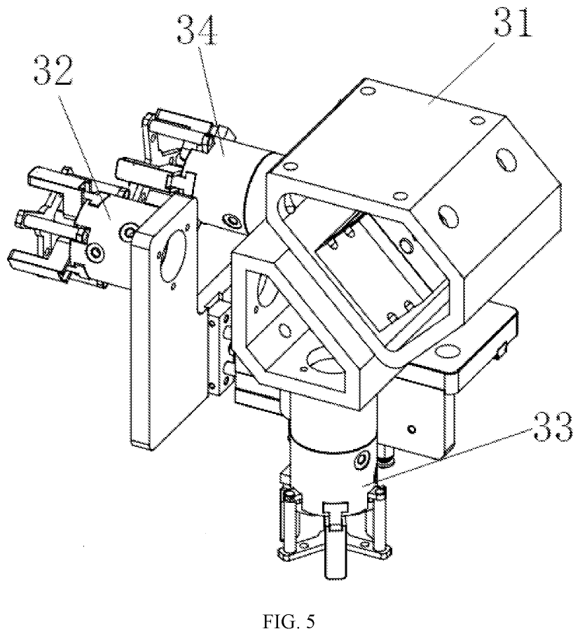

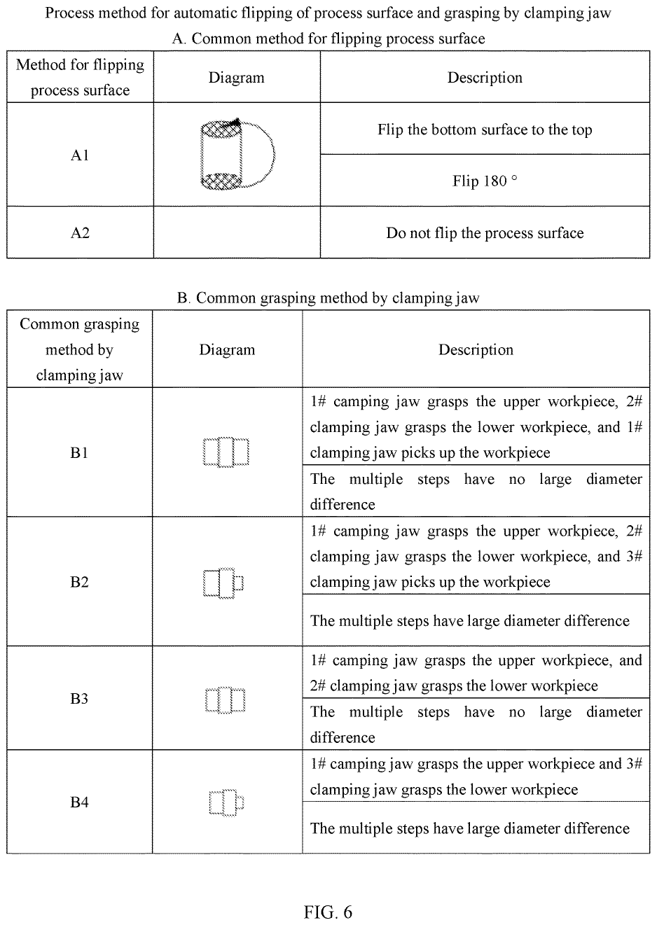

As shown in FIG. 1-6, a process method for automatic feeding and discharging for CNC lathe, comprising the following steps:
S1. A process flow in which a trust manipulator performs the first feeding and discharging for the CNC lathe when the CNC lathe is processing a single-procedure product;
S2. A process flow in which a trust manipulator performs the second feeding and discharging for the CNC lathe (and all subsequent unprocessed materials in this procedure) when the CNC lathe is processing a single-procedure product;
S3: A process flow in which a trust manipulator performs the first feeding and discharging in the first procedure for the CNC lathe when the CNC lathe is processing a multi-procedure product;
S4: A process flow in which a trust manipulator performs the second feeding and discharging in the first procedure for the CNC lathe (and all subsequent unprocessed materials in this procedure) when the CNC lathe is processing a multi-procedure product;
S5: A process flow in which a trust manipulator performs the first feeding and discharging in the second procedure for the CNC lathe when the CNC lathe is processing a multi-procedure product;
S6: A process flow in which a trust manipulator performs the second feeding and discharging in the second procedure for the CNC lathe (and all subsequent unprocessed materials in this procedure) when the CNC lathe is processing a multi-procedure product;
The process surface used for automatic feeding and discharging for CNC lathe can be automatically flipped and grasped without manual flipping, reducing production costs and improving the production efficiency of CNC lathes; the process method can complete the production of multi-procedure finished products by a single machine, reduce the number of machines, while making large improvement in terms of production capacity, yield rate and personnel working environment, and effectively controlling the processing costs free from the restriction of personnel management in the processing industry.

S1 comprises the following specific steps:
S11: Manually place unprocessed material on a material platform;
S12: The truss manipulator grasps unprocessed material from the material platform through 1 #clamping jaw on the clamping jaw mechanism, and the clamping jaw mechanism driven by the truss manipulator moves to an appropriate position outside the CNC lathe, and waits for the CNC lathe to complete the processing of the material from the previous procedure;
S13: After the material from the previous procedure is processed, the clamping jaw mechanism driven by the truss manipulator moves to the appropriate position on the chuck of the CNC lathe, 2 #clamping jaw grasps the processed material on the chuck, the clamping jaw mechanism rotates 1 #clamping jaw to an appropriate working position to place the unprocessed material into the chuck and, under the drive of truss manipulator, the clamping jaw mechanism clamping processed material moves outside the CNC lathe;
S14: Under the drive of truss manipulator, the clamping jaw mechanism clamping processed material moves to an appropriate position on the material platform, and places processed material back to the corresponding numbered position on the material platform.

S2 comprises the following specific steps:
S21: The truss manipulator grasps unprocessed material from material platform through 1 #clamping jaw on the clamping jaw mechanism, the clamping jaw mechanism driven by the truss manipulator moves to an appropriate position outside the CNC lathe, and waits for the CNC lathe to complete the processing of the material from the previous procedure;
S22: After the material from the previous procedure is processed, the clamping jaw mechanism driven by truss manipulator moves to an appropriate position on the chuck of the CNC lathe, 2 #clamping jaw grasps the processed material on the chuck, the clamping jaw mechanism rotates 1 #clamping jaw to the appropriate working position to place unprocessed material b on the chuck and, under the drive of truss manipulator, the clamping jaw mechanism clamping processed material moves outside the CNC lathe;
S23: Under the drive of truss manipulator, the clamping jaw mechanism clamping processed material moves to an appropriate position on the material platform, and places processed material back to the corresponding numbered position on the material platform.

S24: After the truss manipulator performs operations for the CNC lathe for the third time, the process flow of feeding and discharging of all materials is the same as that of the second time, repeat the steps S21, S22 and S23 continuously to automatically complete the feeding and discharging of all materials on the material platform.

S3 comprises the following specific steps:
S31: Manually place unprocessed material on the material platform;
S32: The truss manipulator grasps unprocessed material from the material platform through 1 #clamping jaw on the clamping jaw mechanism, and the clamping jaw mechanism driven by the truss manipulator moves to an appropriate position outside the CNC lathe, and waits for the CNC lathe to complete the processing of the material from the previous procedure;
S33: After the material from the previous procedure is processed, the clamping jaw mechanism driven by truss manipulator moves to an appropriate position on the chuck of the CNC lathe, 2 #clamping jaw grasps the processed material on the chuck, the clamping jaw mechanism rotates 1 #clamping jaw to an appropriate working position to place the unprocessed material a into the chuck and, under the drive of truss manipulator, the clamping jaw mechanism clamping processed material moves outside the CNC lathe;
S34: Driven by the truss manipulator, the clamping jaw mechanism clamping processed material moves to an appropriate position on the material transfer platform, places processed material on a material tray of the material transfer platform and, according to the material processing technology and material size, the clamping jaw mechanism rotates 1 #clamping jaw to the working position;
S35: According to the needs of flipping process surface during material processing, the automatic process surface flipping mechanism grasps processed material from the material tray of transfer platform, and after flipping to the process surface in the second procedure, places the processed material back on the material tray of material transfer platform to meet the needs of flipping process surface of processed material;
S36: Driven by the truss manipulator, 1 #clamping jaw of clamping jaw mechanism grasps, from the material tray of material transfer platform, the processed material for which the process surface has been flipped, and moves and places processed material back to the corresponding numbered position on the material platform.

S4 comprises the following specific steps:
S41: The clamping jaw mechanism rotates 1 #clamping jaw to the working position, the 1 #clamping jaw on the clamping jaw mechanism grasps the unprocessed material, and under the drive of the truss manipulator, moves to an appropriate position outside the CNC lathe, and waits for the CNC lathe to complete the processing of the material from the previous procedure;
S42: After the material from the previous procedure is processed, the clamping jaw mechanism driven by the truss manipulator moves to an appropriate position on the chuck of the CNC lathe, 2 #clamping jaw grasps the processed material on the chuck, the clamping jaw mechanism rotates 1 #clamping jaw to the working position to place unprocessed material on the chuck and, under the drive of the truss manipulator, the clamping jaw mechanism clamping the processed material moves outside the CNC lathe;
S43: Driven by the truss manipulator, the clamping jaw mechanism clamping processed material moves to an appropriate position on the material transfer platform, places processed material on a material tray of the material transfer platform and, according to the material processing technology and material size, the clamping jaw mechanism rotates or moves 1 #clamping jaw to the working position;
S44: According to the needs of flipping process surface during material processing, the automatic process surface flipping mechanism grasps processed material from the material tray of transfer platform, and after flipping to the process surface in the second procedure, places the processed material back on the material tray of material transfer platform to meet the needs of flipping process surface of processed material;
S45: Driven by the truss manipulator, 1 #clamping jaw of clamping jaw mechanism grasps, from the material tray of material transfer platform, the processed material for which the process surface has been flipped, moves and places processed material back to the corresponding numbered position on the material platform;
S46: After the truss manipulator performs the third feeding and discharging for the CNC lathe in the first procedure, the process flow of feeding and discharging all materials is the same as the second feeding and discharging in the first procedure, and repeat steps S41, S42, S43, S44, and S45 continuously to automatically complete the feeding and discharging of all materials on the material platform and the flipping of process surface in the first procedure;
S47: The CNC lathe switches to the second procedure of material processing under manual operation.

S5 comprises the following specific steps:
S51: The truss manipulator grasps the material for secondary processing from the material platform through 1 #clamping jaw on the clamping jaw mechanism, and the clamping jaw mechanism driven by the truss manipulator moves to an appropriate position outside the CNC lathe, and waits for the CNC lathe to complete the processing of the material from the previous procedure;
S52: After the material from the previous procedure is processed, the clamping jaw mechanism driven by the truss manipulator moves to an appropriate position on the chuck of the CNC lathe, 3 #clamping jaw grasps the processed material on the chuck, and the clamping jaw mechanism rotates 1 #clamping jaw to the appropriate working position to place the material for secondary processing into the chuck and, under the drive of the truss manipulator, the clamping jaw mechanism clamping processed material moves outside the CNC lathe;
S53: Driven by the truss manipulator, the clamping jaw mechanism clamping processed material moves to an appropriate position on the material platform to place the secondary-processed material back to the corresponding numbered position on the material platform.

S6 comprises the following specific steps:
S61: The clamping jaw mechanism rotates 1 #clamping jaw to the working position, the 1 #clamping jaw on the clamping jaw mechanism grasps the material for secondary processing, and under the drive of the truss manipulator, moves to an appropriate position outside the CNC lathe, and waits for the CNC lathe to complete the processing of the material from the previous procedure;
S62: After the material from the previous procedure is processed, the clamping jaw mechanism driven by the truss manipulator moves to an appropriate position on the chuck of the CNC lathe, 3 #clamping jaw grasps the secondary-processed material on the chuck, the clamping jaw mechanism rotates 1 #clamping jaw to the working position to place the material for secondary processing on the chuck and, under the drive of the truss manipulator, the clamping jaw mechanism clamping the secondary-processed material moves outside the CNC lathe;
S63: Driven by the truss manipulator, the clamping jaw mechanism clamping secondary-processed material moves to an appropriate position on the material transfer platform, and places secondary-processed material on the corresponding numbered position on the material platform;
S64: After the truss manipulator performs the third feeding and discharging for the CNC lathe in the second procedure, the process flow of feeding and discharging all materials is the same as the second feeding and discharging in the second procedure, and repeat steps S61, S62, and S63 continuously to automatically complete the feeding and discharging of all materials on the material platform in the second procedure until all materials on the material platform are processed;
The automatic feeding and discharging equipment comprises a bracket 1, a material transfer platform 4, a second material transfer platform 7, and a material platform body 10, the upper end of the bracket 1 is fixedly connected to a feeding and discharging manipulator 2, the front end of the feeding and discharging manipulator 2 is fixedly installed with a clamping jaw mechanism 3, the upper end of the material transfer platform 4 is fixedly installed with an automatic process surface flipping mechanism 5 and a transfer platform material tray 6, respectively, and the upper end of the second material transfer platform 7 is fixedly installed with a second automatic process surface flipping mechanism 8 and a second transfer platform material tray 9, respectively, and the upper end of the material platform body 10 is fixedly installed with a material tray 11 of material platform, and based on the newly added first material transfer platform and the improvement of existing clamping jaw mechanism, the automatic process surface flipping and clamping jaw used for the automatic feeding and discharging for CNC lathe can grasp material without manual flipping, reducing production cost and improving the production efficiency of CNC lathe.

The clamping jaw mechanism 3 comprises a clamping jaw control console 31 that is fixedly installed at the front end of the feeding and discharging manipulator 2, and the side ends of clamping jaw control console 31 are fixedly installed with 1 #clamping jaw 32 and 2 #clamping jaw 33, and the lower end of the clamping jaw control console 31 is fixedly installed with 3 #clamping jaw 34, and the upper end of the material transfer platform 4 is also fixedly installed with a vision system and a scanning detection instrument to scan and inspect the external dimensions and surface of processed materials, and based on the multiple clamping jaws installed, the process surface flipping method and grasping method can be directly selected in the control system according to actual needs.

In further, the automatic process surface flipping mechanism comprises two methods for flipping surface process:
A1: Flip the bottom to the top (180)°;
A2: Do not flip the process surface;
There are four methods for grasping by clamping jaw:
B1: there is little difference in clamping diameter before and after material processing. 1 #clamping jaw clamps the upper workpiece, 2 #clamping jaw clamps the lower workpiece and 1 #clamp picks up the workpiece;
B2: there is little difference in clamping diameter before and after material processing. 1 #clamping jaw clamps the upper workpiece, 2 #clamping jaw clamps the lower workpiece and 3 #clamp picks up the workpiece;
B3: there is little difference in clamping diameter before and after material processing. 1 #clamping jaw clamps the upper workpiece, and 2 #clamping jaw clamps the lower workpiece;
B4: there is a large difference in clamping diameter before and after material processing. 1 #clamping jaw clamps the upper workpiece and 3 #clamping jaw clamps the lower workpiece.

Based on the effective arrangement and combination of the process surface flipping methods and the grasping methods by clamping jaw, four common process methods can be combined.

In the present invention, the process method of automatic process surface flipping and grasping by clamping jaw for feeding and discharging for CNC lathe can automatically flip and grasp materials without manual flipping, reducing production costs and improving the production efficiency of CNC lathes; the process method can complete the production of multi-procedure finished products by a single machine, reduce the number of machines, while making large improvement in terms of production capacity, yield rate and personnel working environment, and effectively controlling the processing costs free from the restriction of personnel management in the processing industry.

The scope of protection of the present invention is not limited to the above embodiments, which are merely the preferred ones, of the present invention. Any equivalent substitution or change made by any person skilled in the art within the technical scope disclosed in the present invention based on the technical solution and its improved concept of the present invention shall be covered within the scope of protection hereof.

1. A process method for automatic feeding and discharging for CNC lathe, comprising the following steps:
S1. A process flow in which a trust manipulator performs the first feeding and discharging for the CNC lathe when the CNC lathe is processing a single-procedure product;
S2. A process flow in which a trust manipulator performs the second feeding and discharging for the CNC lathe (and all subsequent unprocessed materials in this procedure) when the CNC lathe is processing a single-procedure product;
S3: A process flow in which a trust manipulator performs the first feeding and discharging in the first procedure for the CNC lathe when the CNC lathe is processing a multi-procedure product;
S4: A process flow in which a trust manipulator performs the second feeding and discharging in the first procedure for the CNC lathe (and all subsequent unprocessed materials in this procedure) when the CNC lathe is processing a multi-procedure product;
S5: A process flow in which a trust manipulator performs the first feeding and discharging in the second procedure for the CNC lathe when the CNC lathe is processing a multi-procedure product;
S6: A process flow in which a trust manipulator performs the second feeding and discharging in the second procedure for the CNC lathe (and all subsequent unprocessed materials in this procedure) when the CNC lathe is processing a multi-procedure product;

2. The process method for automatic feeding and discharging for CNC lathe according to claim 1, wherein S1 comprises the following specific steps:
S11: Manually place unprocessed material on a material platform;
S12: The truss manipulator grasps unprocessed material from the material platform through 1 #clamping jaw on the clamping jaw mechanism, and the clamping jaw mechanism driven by the truss manipulator moves to an appropriate position outside the CNC lathe, and waits for the CNC lathe to complete the processing of the material from the previous procedure;
S13: After the material from the previous procedure is processed, the clamping jaw mechanism driven by the truss manipulator moves to the appropriate position on the chuck of the CNC lathe, 2 #clamping jaw grasps the processed material on the chuck, the clamping jaw mechanism rotates 1 #clamping jaw to an appropriate working position to place the unprocessed material into the chuck and, under the drive of truss manipulator, the clamping jaw mechanism clamping processed material moves outside the CNC lathe;
S14: Under the drive of truss manipulator, the clamping jaw mechanism clamping processed material moves to an appropriate position on the material platform, and places processed material back to the corresponding numbered position on the material platform.

3. The process method for automatic feeding and discharging for CNC lathe according to claim 1, wherein S2 comprises the following specific steps:
S21: The truss manipulator grasps unprocessed material from material platform through 1 #clamping jaw on the clamping jaw mechanism, the clamping jaw mechanism driven by the truss manipulator moves to an appropriate position outside the CNC lathe, and waits for the CNC lathe to complete the processing of the material from the previous procedure;
S22: After the material from the previous procedure is processed, the clamping jaw mechanism driven by truss manipulator moves to an appropriate position on the chuck of the CNC lathe, 2 #clamping jaw grasps the processed material on the chuck, the clamping jaw mechanism rotates 1 #clamping jaw to the appropriate working position to place unprocessed material b on the chuck and, under the drive of truss manipulator, the clamping jaw mechanism clamping processed material moves outside the CNC lathe;
S23: Under the drive of truss manipulator, the clamping jaw mechanism clamping processed material moves to an appropriate position on the material platform, and places processed material back to the corresponding numbered position on the material platform.
S24: After the truss manipulator performs operations for the CNC lathe for the third time, the process flow of feeding and discharging of all materials is the same as that of the second time, repeat the steps S21, S22 and S23 continuously to automatically complete the feeding and discharging of all materials on the material platform.

4. The process method for automatic feeding and discharging for CNC lathe according to claim 1, wherein S3 comprises the following specific steps:
S31: Manually place unprocessed material on the material platform;
S32: The truss manipulator grasps unprocessed material from the material platform through 1 #clamping jaw on the clamping jaw mechanism, and the clamping jaw mechanism driven by the truss manipulator moves to an appropriate position outside the CNC lathe, and waits for the CNC lathe to complete the processing of the material from the previous procedure;
S33: After the material from the previous procedure is processed, the clamping jaw mechanism driven by truss manipulator moves to an appropriate position on the chuck of the CNC lathe, 2 #clamping jaw grasps the processed material on the chuck, the clamping jaw mechanism rotates 1 #clamping jaw to an appropriate working position to place the unprocessed material a into the chuck and, under the drive of truss manipulator, the clamping jaw mechanism clamping processed material moves outside the CNC lathe;
S34: Driven by the truss manipulator, the clamping jaw mechanism clamping processed material moves to an appropriate position on the material transfer platform, places processed material on a material tray of the material transfer platform and, according to the material processing technology and material size, the clamping jaw mechanism rotates 1 #clamping jaw to the working position;
S35: According to the needs of flipping process surface during material processing, the automatic process surface flipping mechanism grasps processed material from the material tray of transfer platform, and after flipping to the process surface in the second procedure, places the processed material back on the material tray of material transfer platform to meet the needs of flipping process surface of processed material;
S36: Driven by the truss manipulator, 1 #clamping jaw of clamping jaw mechanism grasps, from the material tray of material transfer platform, the processed material for which the process surface has been flipped, and moves and places processed material back to the corresponding numbered position on the material platform.

5. The process method for automatic feeding and discharging for CNC lathe according to claim 1, wherein S4 comprises the following specific steps:
S41: The clamping jaw mechanism rotates 1 #clamping jaw to the working position, the 1 #clamping jaw on the clamping jaw mechanism grasps the unprocessed material, and under the drive of the truss manipulator, moves to an appropriate position outside the CNC lathe, and waits for the CNC lathe to complete the processing of the material from the previous procedure;
S42: After the material from the previous procedure is processed, the clamping jaw mechanism driven by the truss manipulator moves to an appropriate position on the chuck of the CNC lathe, 2 #clamping jaw grasps the processed material on the chuck, the clamping jaw mechanism rotates 1 #clamping jaw to the working position to place unprocessed material on the chuck and, under the drive of the truss manipulator, the clamping jaw mechanism clamping the processed material moves outside the CNC lathe;
S43: Driven by the truss manipulator, the clamping jaw mechanism clamping processed material moves to an appropriate position on the material transfer platform, places processed material on a material tray of the material transfer platform and, according to the material processing technology and material size, the clamping jaw mechanism rotates or moves 1 #clamping jaw to the working position;
S44: According to the needs of flipping process surface during material processing, the automatic process surface flipping mechanism grasps processed material from the material tray of transfer platform, and after flipping to the process surface in the second procedure, places the processed material back on the material tray of material transfer platform to meet the needs of flipping process surface of processed material;
S45: Driven by the truss manipulator, 1 #clamping jaw of clamping jaw mechanism grasps, from the material tray of material transfer platform, the processed material for which the process surface has been flipped, moves and places processed material back to the corresponding numbered position on the material platform;
S46: After the truss manipulator performs the third feeding and discharging for the CNC lathe in the first procedure, the process flow of feeding and discharging all materials is the same as the second feeding and discharging in the first procedure, and repeat steps S41, S42, S43, S44, and S45 continuously to automatically complete the feeding and discharging of all materials on the material platform and the flipping of process surface in the first procedure;
S47: The CNC lathe switches to the second procedure of material processing under manual operation.

6. The process method for automatic feeding and discharging for CNC lathe according to claim 1, wherein S5 comprises the following specific steps:
S51: The truss manipulator grasps the material for secondary processing from the material platform through 1 #clamping jaw on the clamping jaw mechanism, and the clamping jaw mechanism driven by the truss manipulator moves to an appropriate position outside the CNC lathe, and waits for the CNC lathe to complete the processing of the material from the previous procedure;
S52: After the material from the previous procedure is processed, the clamping jaw mechanism driven by the truss manipulator moves to an appropriate position on the chuck of the CNC lathe, 3 #clamping jaw grasps the processed material on the chuck, and the clamping jaw mechanism rotates 1 #clamping jaw to the appropriate working position to place the material for secondary processing into the chuck and, under the drive of the truss manipulator, the clamping jaw mechanism clamping processed material moves outside the CNC lathe;
S53: Driven by the truss manipulator, the clamping jaw mechanism clamping processed material moves to an appropriate position on the material platform to place the secondary-processed material back to the corresponding numbered position on the material platform.

7. The process method for automatic feeding and discharging for CNC lathe according to claim 1, wherein S6 comprises the following specific steps:
S61: The clamping jaw mechanism rotates 1 #clamping jaw to the working position, the 1 #clamping jaw on the clamping jaw mechanism grasps the material for secondary processing, and under the drive of the truss manipulator, moves to an appropriate position outside the CNC lathe, and waits for the CNC lathe to complete the processing of the material from the previous procedure;
S62: After the material from the previous procedure is processed, the clamping jaw mechanism driven by the truss manipulator moves to an appropriate position on the chuck of the CNC lathe, 3 #clamping jaw grasps the secondary-processed material on the chuck, the clamping jaw mechanism rotates 1 #clamping jaw to the working position to place the material for secondary processing on the chuck and, under the drive of the truss manipulator, the clamping jaw mechanism clamping the secondary-processed material moves outside the CNC lathe;
S63: Driven by the truss manipulator, the clamping jaw mechanism clamping secondary-processed material moves to an appropriate position on the material transfer platform, and places secondary-processed material on the corresponding numbered position on the material platform;
S64: After the truss manipulator performs the third feeding and discharging for the CNC lathe in the second procedure, the process flow of feeding and discharging all materials is the same as the second feeding and discharging in the second procedure, and repeat steps S61, S62, and S63 continuously to automatically complete the feeding and discharging of all materials on the material platform in the second procedure until all materials on the material platform are processed;

8. The process method for automatic feeding and discharging for CNC lathe according to claim 1, wherein the automatic feeding and discharging equipment comprises a bracket (1), a material transfer platform (4), a second material transfer platform (7), and a material platform body (10), the upper end of the bracket (1) is fixedly connected to a feeding and discharging manipulator (2), the front end of the feeding and discharging manipulator (2) is fixedly installed with a clamping jaw mechanism (3), the upper end of the material transfer platform (4) is fixedly installed with an automatic process surface flipping mechanism (5) and a transfer platform material tray (6), respectively, and the upper end of the second material transfer platform (7) is fixedly installed with a second automatic process surface flipping mechanism (8) and a second transfer platform material tray (9), respectively, and the upper end of the material platform body (10) is fixedly installed with a material tray (11) of material platform.

9. The process method for automatic feeding and discharging for CNC lathe according to claim 8, wherein the clamping jaw mechanism (3) comprises a clamping jaw control console (31) that is fixedly installed at the front end of the feeding and discharging manipulator (2), and the side ends of clamping jaw control console (31) are fixedly installed with 1 #clamping jaw (32) and 2 #clamping jaw (33), the lower end of the clamping jaw control console (31) is fixedly installed with 3 #clamping jaw (34), and the upper end of the material transfer platform (4) is also fixedly installed with a vision system and a scanning detection instrument.

10. The process method for automatic feeding and discharging for CNC lathe according to claim 8, wherein the automatic process surface flipping mechanism comprises two methods for flipping surface process:
A1: Flip the bottom to the top (180)°;
A2: Do not flip the process surface;
There are four methods for grasping by clamping jaw:
B1: there is little difference in clamping diameter before and after material processing. 1 #clamping jaw clamps the upper workpiece, 2 #clamping jaw clamps the lower workpiece and 1 #clamp picks up the workpiece;
B2: there is little difference in clamping diameter before and after material processing. 1 #clamping jaw clamps the upper workpiece, 2 #clamping jaw clamps the lower workpiece and 3 #clamp picks up the workpiece;
B3: there is little difference in clamping diameter before and after material processing. 1 #clamping jaw clamps the upper workpiece, and 2 #clamping jaw clamps the lower workpiece;
B4: there is a large difference in clamping diameter before and after material processing. 1 #clamping jaw clamps the upper workpiece and 3 #clamping jaw clamps the lower workpiece.
